(19) United States
(12) Patent Application Publication
(10) Pub. No.: US 2026/0317149 A1
(43) Pub. Date: Oct. 15, 2026

(54) HEAT PUMP WATER COOLER AND HEATER

(71) Applicant: Delta Faucet Company, Indianapolis, IN (US)

(72) Inventor: David Lee, Westfield, IN (US)

(21) Appl. No.: 19/642,108

(22) Filed: Apr. 8, 2026

Related U.S. Application Data
(60) Provisional application No. 63/787,663, filed on Apr. 11, 2025.

(51) Int. Cl. B67D 1/08

(52) U.S. Cl. CPC B67D 1/0859; B67D 1/0888; B67D 1/0895

(57) ABSTRACT

A beverage dispensing arrangement illustratively includes a vapor-compression refrigeration system having a closed-loop refrigerant circuit with a compressor, a condenser fluidly coupled to the compressor and receiving refrigerant therefrom, an expansion valve fluidly coupled to the condenser and receiving refrigerant therefrom, and an evaporator fluidly coupled to the expansion valve and receiving refrigerant therefrom. The compressor is fluidly coupled to the evaporator and receives refrigerant therefrom. A hot water tank receives water and includes the condenser, a water inlet and a hot water outlet. The hot water outlet may be fluidly coupled to a hot water dispenser. A cold water tank receives water and includes the evaporator, a water inlet and a cold water outlet. The cold water outlet may be fluidly coupled to a cold water dispenser.

### CROSS-REFERENCE TO RELATED APPLICATION

The present application claims priority to U.S. Provisional Patent Application Ser. No. 63/787,663, filed Apr. 11, 2025, the disclosure of which is expressly incorporated herein by reference.

### BACKGROUND AND SUMMARY OF THE DISCLOSURE

The present invention relates generally to a water heating and cooling system and, more particularly, to a system for heating and cooling drinking water.

Instant hot water tanks typically use resistive heating elements to heat water. Water coolers, including refrigerator water dispensers, typically use a working fluid and a refrigeration cycle to dump excess heat in water to the environment to chill water.

The present disclosure uses a refrigeration cycle to refrigerate water on one side (i.e., cold side) of a heat pump, and heat water on the other side (i.e., hot side) of the heat pump. This arrangement avoids the wasted energy that results from use of resistive heating elements, and reduces the heat generated from the refrigeration cycle that is exhausted to the associated cabinet space.

The present disclosure provides a fluid dispensing system, illustratively a beverage dispensing system, including a hot water tank and a cold water tank. A heat pump system transfers heat from the cold water tank to the hot water tank. The cold water tank and the hot water tank are both illustratively lined with, or include, internal coils around which water is circulated. The hot water tank side is illustratively the condenser coil. The cold water tank side is illustratively the evaporator coil.

The working fluid illustratively flows from the condenser to the evaporator (hot to cold) through an expansion valve. The working fluid illustratively flows from the evaporator to the condenser (cold to hot) through a compressor, which also acts as the pumping mechanism to circulate the working fluid through the system.

Using both hot water and cold water simultaneously is not a common need in heating, ventilation and air conditioning (HVAC) space or in commercial or residential spaces at high volume. However, having both hot water and cold water accessible from one device in a beverage dispenser would be of great convenience.

According to an illustrative embodiment of the present disclosure, a beverage dispensing arrangement comprises a vapor-compression refrigeration system including a closed-loop refrigerant circuit having a compressor, a condenser fluidly coupled to the compressor and receiving refrigerant therefrom, an expansion valve fluidly coupled to the condenser and receiving the refrigerant therefrom, and an evaporator fluidly coupled to the expansion valve and receiving the refrigerant therefrom. The compressor is fluidly coupled to the evaporator and receives the refrigerant therefrom. A hot water tank contains the condenser and has a water inlet and a hot water outlet. The hot water tank contains water. The water inlet is fluidly coupled to a water supply. The hot water outlet is fluidly coupled to a hot water dispenser. A cold water tank contains the evaporator and has a water inlet and a cold water outlet. The cold water tank contains water. The water inlet is fluidly coupled to a water supply. The cold water outlet is fluidly coupled to a cold water dispenser.

According to another illustrative embodiment of the present disclosure, a beverage dispensing arrangement comprises a refrigeration system including a closed-loop refrigerant circuit having a condenser converting refrigerant from a gaseous state to a liquid state, and an evaporator converting the refrigerant from a liquid state to a gaseous state. A hot water tank contains the condenser and has a water inlet and a hot water outlet. The hot water tank contains water that receives heat from the condenser. The water inlet is fluidly coupled to a water supply. The hot water outlet is fluidly coupled to a hot water dispenser. A cold water tank contains the evaporator and has a water inlet and a cold water outlet. The cold water tank contains water that transfers heat to the evaporator. The water inlet is fluidly coupled to a water supply. The cold water outlet is fluidly coupled to a cold water dispenser.

According to yet another illustrative embodiment of the present disclosure, a beverage dispensing arrangement includes a refrigeration system having a first heat transfer element and a second heat transfer element. The second heat transfer element has an operating temperature that is lower than an operating temperature of the first heat transfer element. A hot water tank has a water inlet and a hot water outlet. The hot water tank contains water that receives heat from the first heat transfer element. The water inlet is fluidly coupled to a water supply. The hot water outlet is fluidly coupled to a hot water dispenser. A cold water tank has a water inlet and a cold water outlet. The cold water tank contains water that transfers heat to the second heat transfer element. The water inlet is fluidly coupled to a water supply. The cold water outlet is fluidly coupled to a cold water dispenser. A first temperature sensor measures a temperature of water associated with the hot water tank. A second temperature sensor measures a temperature of water associated with the cold water tank. An electronic processor is communicatively coupled to the refrigeration system, the first temperature sensor and the second temperature sensor. The electronic processor controls operation of the refrigeration system dependent upon temperatures signals emitted by the first temperature sensor and the second temperature sensor.

According to a further illustrative embodiment of the present disclosure, a beverage dispensing arrangement includes a refrigeration system having a first heat transfer element, and a second heat transfer element, the second heat transfer element having an operating temperature that is lower than an operating temperature of the first heat transfer element. A hot water tank includes a water inlet and a hot water outlet. The hot water tank is configured to contain water receiving heat from the first heat transfer element. The water inlet is configured to be fluidly coupled to a water supply. The hot water outlet is configured to be fluidly coupled to a hot water dispenser. A cold water tank includes a water inlet and a cold water outlet. The cold water tank is configured to contain water transferring heat to the second heat transfer element. The water inlet is configured to be fluidly coupled to a water supply. The cold water outlet is configured to be fluidly coupled to a cold water dispenser.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of an illustrative heat pump water cooler and heater of the present disclosure;

FIG. 2 is another schematic diagram of the illustrative heat pump water cooler and heater of FIG. 1, including temperature sensors, for use in a beverage system;

FIG. 3 is a block diagram of an illustrative microprocessor-based feedback control system for the heat pump water cooler and heater of FIG. 2;

FIG. 4 is a schematic diagram of another illustrative heat pump water cooler and heater of the present disclosure;

FIG. 5 is a schematic diagram of a low pressure side of yet another illustrative heat pump water cooler and heater; and

FIG. 6 is a schematic diagram of a low pressure side of a further illustrative heat pump water cooler and heater.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

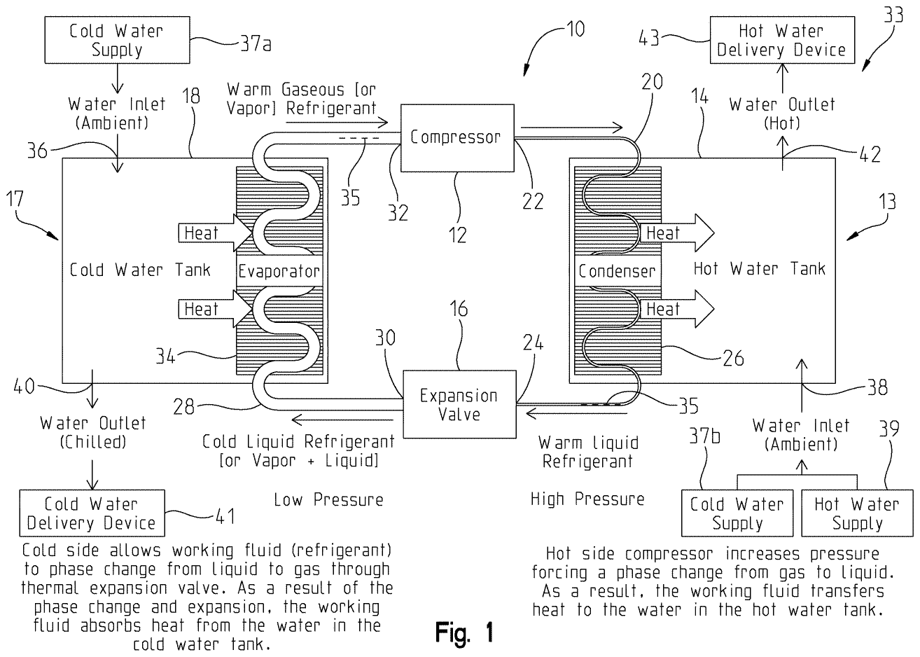

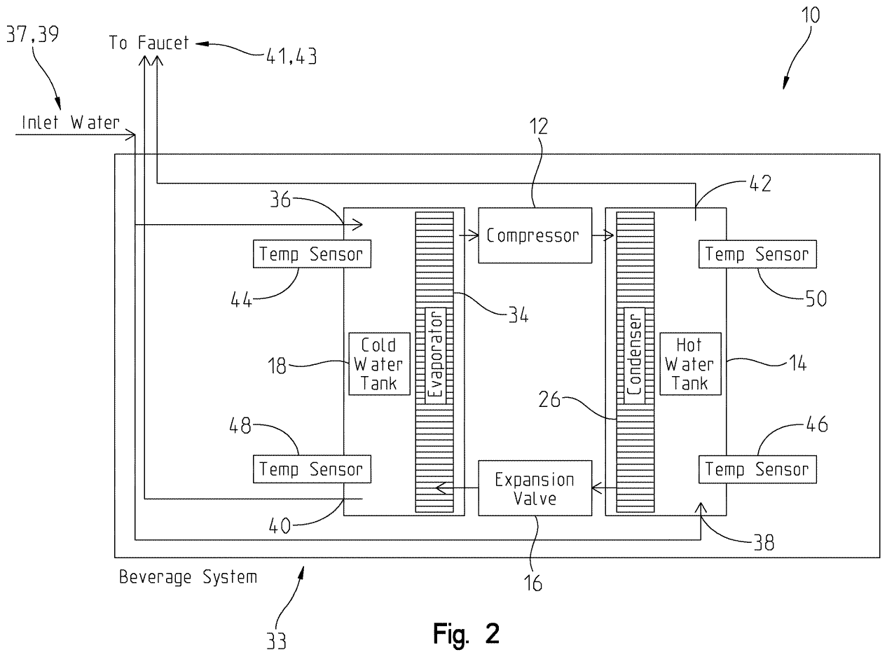

Referring initially to FIG. 1, an illustrative heat pump water cooler and heater 10 of the present disclosure includes a compressor 12, a hot side 13 including a hot water tank 14, an expansion valve 16 and a cold side 17 including a cold water tank 18. Compressor 12, condenser 26, expansion valve 16 and evaporator 34 may function as a vapor-compression refrigeration system. With reference to FIG. 2, heat pump water cooler and heater 10 may serve as a fluid (e.g., beverage) dispensing arrangement or system 33 that dispenses cold water and/or hot water at temperatures that are preferred for drinking and/or for making hot beverages, such as tea.

With further reference to FIG. 1, a coiled conduit 20 fluidly couples an outlet 22 of the compressor 12 to an inlet 24 of the expansion valve 16 and, in-between, follows a serpentine path through a condenser 26 thermally coupled to the hot water tank 14. Another coiled conduit 28 fluidly couples an outlet 30 of the expansion valve 16 to an inlet 32 of the compressor 12 and, in-between, follows a serpentine path through an evaporator 34 thermally coupled to the cold water tank 18. Conduit 28 may have a larger width or diameter (cross-sectional area) than conduit 20. As further detailed herein, a working fluid 35 is received within the conduits 20 and 28.

The cold water tank 18 illustratively includes an ambient water inlet 36 that may receive water from a cold water supply 37a. The hot water tank 14 illustratively includes an ambient water inlet 38 that may receive water from either a cold water supply 37b or a hot water supply 39. Chilled water exits cold water tank 18 through a water outlet 40. Water outlet 40 may provide water to a cold water delivery device 41, such as a cold water dispenser or faucet (not shown). Hot water exits hot water tank 14 through a water outlet 42. Water outlet 42 may provide water to a hot water delivery device 43, such as a hot water dispenser or faucet (not shown).

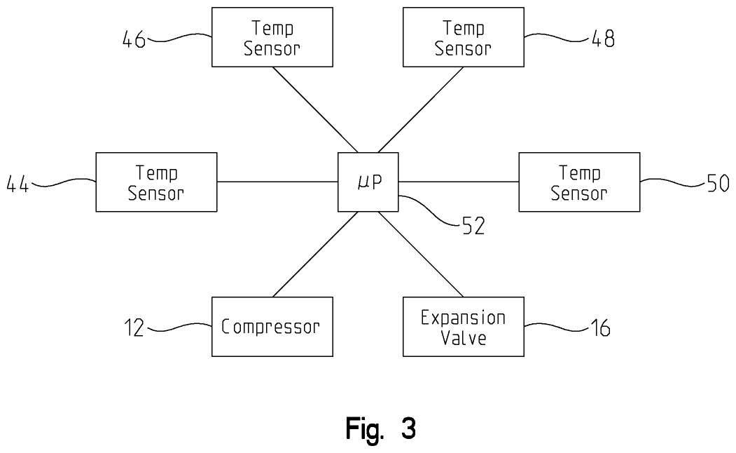

As shown in FIG. 2, a temperature sensor 44 measures the temperature of water at water inlet 36, a temperature sensor 46 measures the temperature of water at water inlet 38, a temperature sensor 48 measures the temperature of water at cold water outlet 40, and a temperature sensor 50 measures the temperature of water at hot water outlet 42. A controller 52 (illustratively, an electronic microprocessor) is illustratively in electrical communication with temperature sensors 44, 46, 48, 50 (FIG. 3). Based on temperature measurements from sensors 44, 46, 48, 50, an electronic processor 52 may control operation of the compressor 12 and/or the expansion valve 16 to thereby adjust the water temperatures at water inlets 36, 38, cold water outlet 40 and/or hot water outlet 42.

The cold side 17 (including, the cold water tank 18) causes the working fluid 35 (e.g., refrigerant, illustratively hydrofluorocarbons (HFCs) such as R-410A (often referred to as Puron) or R-454B (often referred to as Opteon XL41, Solstice 454B, or Puron Advance) to phase change from liquid to gas in the evaporator 34 after passing through the thermal expansion valve 16. As a result of the expansion and phase change, the working fluid 35 absorbs heat from the water in the cold water tank 18.

The compressor 12 increases the pressure of the working fluid 35. The hot side 13 (including the hot water tank 14) forces a phase change from gas to liquid in the condenser 26. As a result, the working fluid 35 transfers heat to the water in the hot water tank 14.

If the hot water demand rate is higher than the illustrative heat pump water cooler and heater 10 can support, a resistive heating element may be added within the scope of the disclosure in order to support faster heating.

Although the temperature sensors 44, 46, 48, 50 have been described as measuring the temperature of water in the tanks 14 and 18, it is also possible within the scope of the disclosure to measure the temperature of the refrigerant and to control operation of the compressor 12 and the expansion valve 16 based on refrigerant temperature.

Although coiled conduit 20 has been described as following a serpentine path through the condenser 26, and coiled conduit 28 has been described as following a serpentine path through the evaporator 34 to improve heat transfer efficiency, it is to be understood that the conduits 20, 28 can follow paths other than serpentine (e.g., coiled or other curved paths).

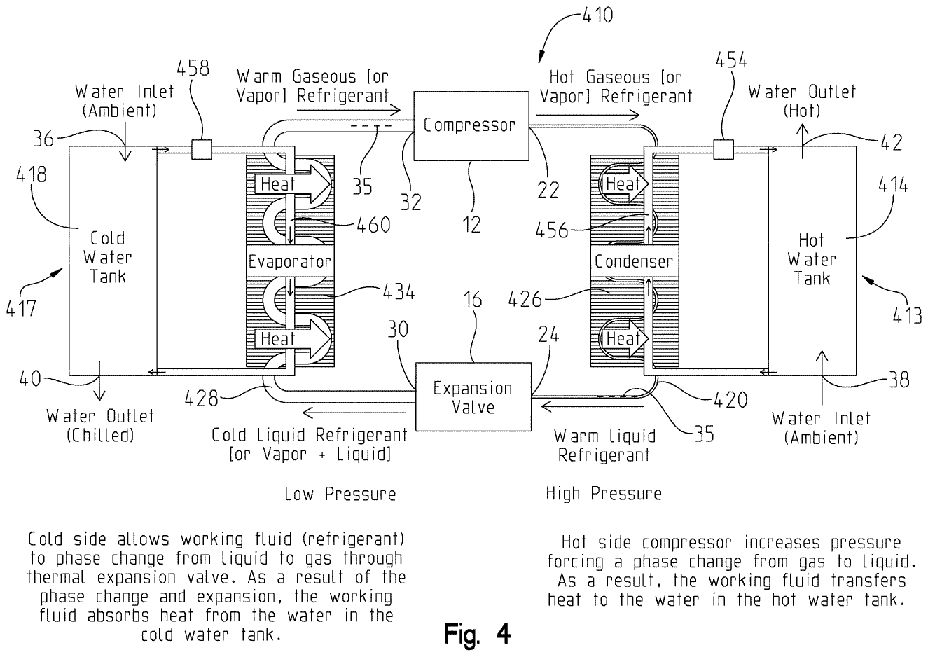

With reference now to FIG. 4, there is shown another illustrative heat pump water cooler and heater 410 of the present disclosure. In the following description, similar components are identified with like reference numbers.

In the illustrative embodiment of FIG. 4, coiled conduits 420, 428 are not submerged in the hot water tank 414 of the hot water side 413 or in the cold water tank 418 of the cold water side 417. Rather, water is circulated between the hot water tank 414 and the heating heat exchanger with the condenser 426, and is circulated between the cold water tank 418 and the cooling heat exchanger with the evaporator 434. More particularly, a first water pump 454 circulates water between the hot water tank 414 and a conduit 456 that extends through the heating heat exchanger with the condenser 426. Heat is transferred from condenser 426 to conduit 456. Similarly, a second water pump 458 circulates water between the cold water tank 418 and a conduit 460 that extends through the cooling heat exchanger with the evaporator 434. Heat is transferred from conduit 460 to evaporator 434.

Conduits 456, 460 are shown in FIG. 4 as extending straight through condenser 426 and evaporator 434, respectively. However, it is possible for conduits 456, 460 to follow serpentine, coiled, or similar paths in order to improve the heat transfer efficiency. Other features of heat pump water cooler and heater 410 may be substantially similar to those of heat pump water cooler and heater 10, and thus are not repeated herein in order to avoid needless repetition. Other types of liquid-to-liquid heat exchangers can be used on the cooling heat exchanger and the heating heat exchanger.

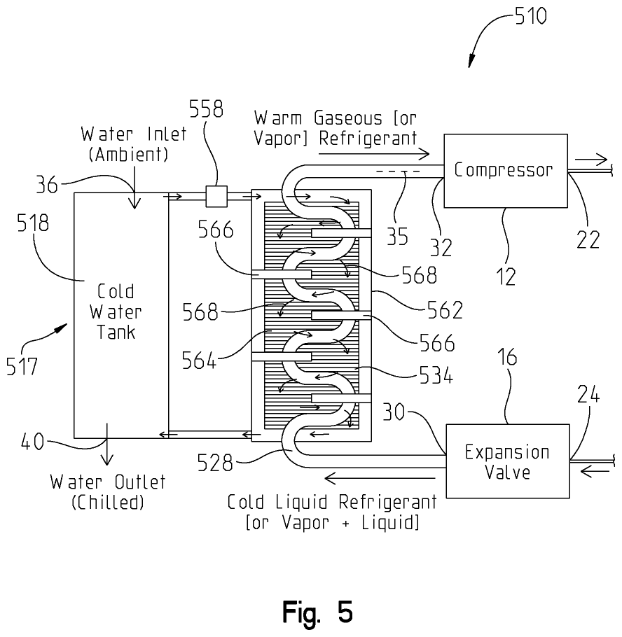

FIG. 5 illustrates another embodiment of a low pressure side of an illustrative heat pump water cooler and heater 510 of the present disclosure. In the following description, similar components are identified with like reference numbers.

In the illustrative embodiment of FIG. 5, coiled conduit 528 is not submerged in the cold water tank 518 of the cold water side 517. Rather, water is circulated between the cold water tank 518 and a cooling heat exchange tank 562 that contains the evaporator 534. Heat is transferred from the water in the cooling heat exchange tank 562 to the evaporator 534. The evaporator 534 includes a heat sink 564 with fins that are horizontally depicted in FIG. 5. The heat sink 564 draws heat from the water in tank 562 and transfers the heat to the refrigerant in coiled conduit 528. Attached to the vertical wall(s) of the cooling heat exchange tank 562 are baffles 566 that cause the water to flow through the tank 562 along a generally downward serpentine path that is indicated by arrows 568 in FIG. 5. This serpentine path of the water results in the water flowing over and between more of the fins of the heat sink 564, and thereby enables more heat to be transferred from the water to the heat sink 564 and to the coiled conduit 528. There may be channels or gaps in the fins of the heat sink 564 to define the path of water flow through the heat sink 564. For example, the heat sink 564 may have a helical shape defining external grooves through which the water may flow. The high pressure side of the heat pump water cooler and heater 510 may be substantially similar to the low pressure side, and is not shown or described in detail herein in order to avoid needless repetition.

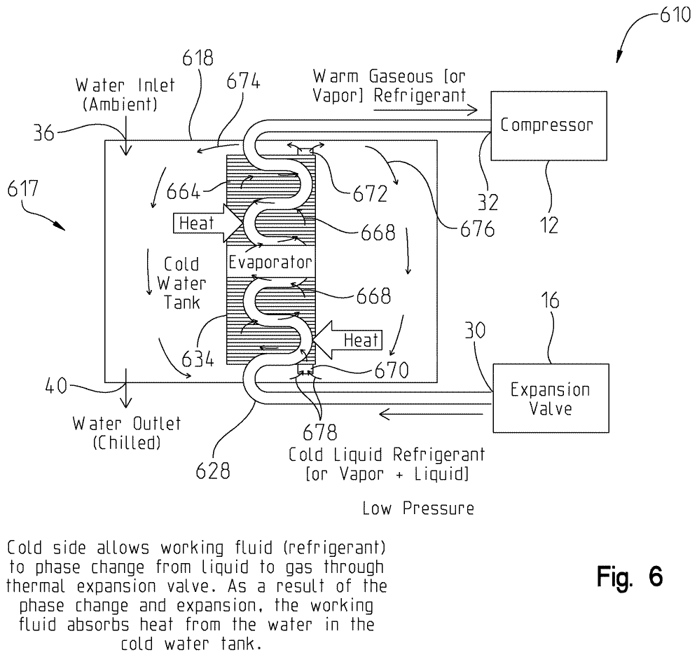

FIG. 6 is a schematic diagram of yet another embodiment of the low pressure side of an illustrative heat pump water cooler and heater 610 of the present disclosure, including a cold side 617 having a cold water tank 618. An evaporator 634 may be more centrally located in the cold water tank 618 than is the evaporator 34 in the cold water tank 18. The central location of the evaporator 634 in the cold water tank reduces thermal losses from the evaporator 634 to the environment. The evaporator 634 has an inlet 670 and an outlet 672.

During use, water enters the ambient water inlet 36 of cold water tank 618 from a pressurized water source (not shown). As the momentum of the incoming water causes the water to flow in a generally downward direction into the tank 618, the moving water suctions another water flow from the evaporator outlet 672, as indicated by arrow 674. Another portion of the water exiting outlet 672 flows to the side of tank 618 that is opposite inlet 36, as indicated by arrow 676.

Because water is suctioned from evaporator outlet 672, water is also suctioned into evaporator inlet 670 from both sides of the water tank 618, as indicated by arrows 678, in order to maintain the circulation of water through the evaporator 634. The evaporator 634 includes a heat sink 664 which may have baffles, channels or gaps in its fins to define a serpentine path of water flow through the heat sink 664, as indicated by arrows 668. Because water is forced through and around the evaporator 634, the transfer of heat may be more even.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A beverage dispensing arrangement comprising:
a vapor-compression refrigeration system including a closed-loop refrigerant circuit having:
a compressor;
a condenser fluidly coupled to the compressor and configured to receive refrigerant therefrom;
an expansion valve fluidly coupled to the condenser and configured to receive the refrigerant therefrom; and
an evaporator fluidly coupled to the expansion valve and configured to receive the refrigerant therefrom, the compressor being fluidly coupled to the evaporator and configured to receive the refrigerant therefrom;
a hot water tank containing the condenser and having a water inlet and a hot water outlet, the hot water tank being configured to contain water, the water inlet being configured to be fluidly coupled to a water supply, the hot water outlet being configured to be fluidly coupled to a hot water dispenser; and
a cold water tank containing the evaporator and having a water inlet and a cold water outlet, the cold water tank being configured to contain water, the water inlet being configured to be fluidly coupled to a water supply, the cold water outlet being configured to be fluidly coupled to a cold water dispenser.

2. The beverage dispensing arrangement of claim 1, wherein the water in the hot water tank is thermally coupled to the condenser.

3. The beverage dispensing arrangement of claim 2, wherein the water in the hot water tank absorbs heat from the condenser.

4. The beverage dispensing arrangement of claim 1, wherein the water in the cold water tank is thermally coupled to the evaporator.

5. The beverage dispensing arrangement of claim 4, wherein the water in the cold water tank transfers heat to the evaporator.

6. The beverage dispensing arrangement of claim 1, further comprising:
a first temperature sensor configured to measure a temperature of water associated with the hot water tank;
a second temperature sensor configured to measure a temperature of water associated with the cold water tank; and
an electronic processor communicatively coupled to the compressor, the expansion valve, the first temperature sensor and the second temperature sensor, the electronic processor being configured to control operation of the compressor and the expansion valve dependent upon temperatures signals emitted by the first temperature sensor and the second temperature sensor.

7. The beverage dispensing arrangement of claim 6, wherein the first temperature sensor is configured to measure a temperature of water exiting the hot water tank, and the second temperature sensor is configured to measure a temperature of water exiting the cold water tank.

8. The beverage dispensing arrangement of claim 1, wherein at least one of the evaporator and the condenser includes an internal channel through which water flows.

9. The beverage dispensing arrangement of claim 1, wherein the evaporator is substantially centrally-located within the cold water tank and/or the condenser is substantially centrally-located within the hot water tank.

10. A beverage dispensing arrangement comprising:
a refrigeration system including a closed-loop refrigerant circuit having:
a condenser configured to convert refrigerant from a gaseous state to a liquid state; and
an evaporator configured to convert the refrigerant from a liquid state to a gaseous state;
a hot water tank containing the condenser and having a water inlet and a hot water outlet, the hot water tank being configured to contain water receiving heat from the condenser, the water inlet being configured to be fluidly coupled to a water supply, the hot water outlet being configured to be fluidly coupled to a hot water dispenser; and
a cold water tank containing the evaporator and having a water inlet and a cold water outlet, the cold water tank being configured to contain water transferring heat to the evaporator, the water inlet being configured to be fluidly coupled to a water supply, the cold water outlet being configured to be fluidly coupled to a cold water dispenser.

11. The beverage dispensing arrangement of claim 10, wherein the water in the hot water tank substantially surrounds the condenser.

12. The beverage dispensing arrangement of claim 10, wherein the water in the hot water tank is thermally coupled to the condenser.

13. The beverage dispensing arrangement of claim 10, wherein the water in the cold water tank substantially surrounds the evaporator.

14. The beverage dispensing arrangement of claim 10, wherein the water in the cold water tank is thermally coupled to the evaporator.

15. The beverage dispensing arrangement of claim 10, further comprising:
a first temperature sensor configured to measure a temperature of water associated with the hot water tank;
a second temperature sensor configured to measure a temperature of water associated with the cold water tank; and
an electronic processor communicatively coupled to the refrigeration system, the first temperature sensor and the second temperature sensor, the electronic processor being configured to control operation of the refrigeration system dependent upon temperatures signals emitted by the first temperature sensor and the second temperature sensor.

16. The beverage dispensing arrangement of claim 15, wherein the first temperature sensor is configured to measure a temperature of water exiting the hot water tank, and the second temperature sensor is configured to measure a temperature of water exiting the cold water tank.

17. The beverage dispensing arrangement of claim 10, wherein at least one of the evaporator and the condenser includes an internal channel through which water flows.

18. The beverage dispensing arrangement of claim 10, wherein the evaporator is substantially centrally-located within the cold water tank and/or the condenser is substantially centrally-located within the hot water tank.

19. A beverage dispensing arrangement comprising:
a refrigeration system including:
a first heat transfer element; and
a second heat transfer element, the second heat transfer element having an operating temperature that is lower than an operating temperature of the first heat transfer element;
a hot water tank having a water inlet and a hot water outlet, the hot water tank being configured to contain water receiving heat from the first heat transfer element, the water inlet being configured to be fluidly coupled to a water supply, the hot water outlet being configured to be fluidly coupled to a hot water dispenser;
a cold water tank having a water inlet and a cold water outlet, the cold water tank being configured to contain water transferring heat to the second heat transfer element, the water inlet being configured to be fluidly coupled to a water supply, the cold water outlet being configured to be fluidly coupled to a cold water dispenser;
a first temperature sensor configured to measure a temperature of water associated with the hot water tank;
a second temperature sensor configured to measure a temperature of water associated with the cold water tank; and
an electronic processor communicatively coupled to the refrigeration system, the first temperature sensor and the second temperature sensor, the electronic processor being configured to control operation of the refrigeration system dependent upon temperatures signals emitted by the first temperature sensor and the second temperature sensor.

20. The beverage dispensing arrangement of claim 19, wherein the water in the hot water tank substantially surrounds the first heat transfer element.

21. The beverage dispensing arrangement of claim 19, wherein the water in the hot water tank is thermally coupled to the first heat transfer element.

22. The beverage dispensing arrangement of claim 19, wherein the water in the cold water tank substantially surrounds the second heat transfer element.

23. The beverage dispensing arrangement of claim 19, wherein the water in the cold water tank is thermally coupled to the second heat transfer element.

24. The beverage dispensing arrangement of claim 19, wherein the first temperature sensor is configured to measure a temperature of water exiting the hot water tank, and the second temperature sensor is configured to measure a temperature of water exiting the cold water tank.

25. The beverage dispensing arrangement of claim 19, wherein at least one of the first heat transfer element and the second heat transfer element includes an internal channel through which water flows.

26. The beverage dispensing arrangement of claim 19, wherein the first heat transfer element is substantially centrally-located within the hot water tank and/or the second heat transfer element is substantially centrally-located within the cold water tank.

27. A beverage dispensing arrangement comprising:
a refrigeration system including:
a first heat transfer element; and
a second heat transfer element, the second heat transfer element having an operating temperature that is lower than an operating temperature of the first heat transfer element;
a hot water tank having a water inlet and a hot water outlet, the hot water tank being configured to contain water receiving heat from the first heat transfer element, the water inlet being configured to be fluidly coupled to a water supply, the hot water outlet being configured to be fluidly coupled to a hot water dispenser; and
a cold water tank having a water inlet and a cold water outlet, the cold water tank being configured to contain water transferring heat to the second heat transfer element, the water inlet being configured to be fluidly coupled to a water supply, the cold water outlet being configured to be fluidly coupled to a cold water dispenser.

28. The beverage dispensing arrangement of claim 27, wherein the water in the hot water tank is thermally coupled to the first heat transfer element.

29. The beverage dispensing arrangement of claim 27, wherein the water in the cold water tank is thermally coupled to the second heat transfer element.

30. The beverage dispensing arrangement of claim 27, wherein at least one of the first heat transfer element and the second heat transfer element includes an internal channel through which water flows.

31. The beverage dispensing arrangement of claim 27, wherein the first heat transfer element is substantially centrally-located within the hot water tank and/or the second heat transfer element is substantially centrally-located within the cold water tank.

32. The beverage dispensing arrangement of claim 21, further comprising:
a first conduit extending through the condenser and fluidly coupled to the hot water tank;
a first pump configured to circulate water between the hot water tank and the condenser;
a second conduit extending through the evaporator and fluidly coupled to the cold water tank; and
a second pump configured to circulate water between the cold water tank and the evaporator.
